(19) United States
(12) Patent Application Publication
(10) Pub. No.: US 2009/0322245 A1
(43) Pub. Date: Dec. 31, 2009

(54) DISCHARGE LAMP LIGHTING APPARATUS

(75) Inventor: Takumi HORIKAWA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TDK CORPORATION, Tokyo (JP)

(21) Appl. No.: 12/247,444

(22) Filed: Oct. 8, 2008

(30) Foreign Application Priority Data
Jun. 30, 2008 (JP) 2008-170906

(51) Int. Cl. H05B 41/16

(52) U.S. Cl. 315/287

(57) ABSTRACT

A discharge lamp lighting apparatus includes a DC/AC converter for converting a supplied direct voltage to an alternating voltage and then outputting the alternating voltage, a high-voltage generator for superposing a pulse voltage on the alternating voltage supplied from the DC/AC converter and then outputting the alternating voltage, and a microprocessor for providing a timing to control the high-voltage generator in such a manner that the pulse voltage is superposed on the alternating voltage in synchronism with the alternating voltage.

### BACKGROUND OF THE INVENTION

1. Field of the Invention

The present invention relates to a discharge lamp lighting apparatus.

2. Description of the Related Art

Recently, high intensity discharge lamps (HID lamps) have been developed as a lighting source of video devices such as projectors, auto headlights, and display lightings. Such discharge lamps are characterized in that high intensity can be obtained with a low power as compared with conventional lighting sources and in particular, are highly promising as a lighting source of projectors and auto headlights.

The high intensity discharge lamps (HID lamps) are generally constructed by sealing mercury in a tube composed of a silica glass or the like with a pair of opposing, spaced-apart electrodes disposed at its opposing ends. In this construction, breakdown occurs between the electrodes with a high voltage applied between the electrodes, thereby generating an arc discharge and producing light.

The electrodes are made of tungsten which sublimates at a temperature exceeding 1100° C. Heat generated when the discharge lamp remains on is thought to include heat due to the collision of electron discharged from one electrode with the other electrode, heat due to the arc discharge itself, and heat due to the power consumption with current flow through the electrodes, but it is though that the direct heating of the electrodes is due to the collision of electron.

Heretofore, various types of discharge lamp lighting apparatus have been proposed for lighting discharge lamps of this type. The proposed discharge lamp lighting apparatuses can be classified into three depending on their starting methods, i.e., a direct current starting method (Japanese Unexamined Patent Application Publication No. 2001-273984), a low frequency starting method, and a high frequency starting method (Japanese Unexamined Patent Application Publication No. 2008-59806). The direct current starting method is a method in which a high-voltage pulse is generated for starting with a constant direct voltage applied between electrodes of a discharge lamp and the direct voltage is maintained for a given length of time after starting the discharge. The low frequency starting method is a method in which a high-voltage pulse is generated with an alternating voltage of a frequency as low as a few hundred Hz applied between electrodes of a discharge lamp and the frequency is maintained after starting the discharge. The high frequency starting method is a method in which a high-voltage pulse is generated with an alternating voltage of a frequency as high as a few dozen kHz applied between electrodes of a discharge lamp and the frequency is maintained after starting the discharge.

In relation to properties of a discharge lamp, these starting methods have not only advantages but also disadvantages that have to be further improved. In case of the direct current starting method, at first, the direction of emission and inflow of electron is fixed because the operation is performed by direct current. Accordingly, only one electrode is heated and worn.

In case of the high frequency starting method, although the voltage polarity between electrodes is changed by current-limiting action of an inductor contained in a discharge lamp lighting apparatus, the current flowing between them is not inverted but remains flowing with only one polarity, creating a triangular current waveform, which also results in heating only one electrode.

The low frequency starting method is superior to the above two starting methods in that it will not heat only one electrode. However, since the light sometimes goes out temporarily upon reversal of polarity, it is difficult to increase the temperature inside the discharge lamp, deteriorating starting performance. This has to be improved.

More specifically, the behavior upon starting is as follows. Right after the breakdown, the inside of the discharge lamp is in a cold state and therefore the sealed mercury is in a liquid state. If the pair of electrodes were equally affected by heat dissipation, the liquid mercury would evenly adhere to these electrodes, but since the discharge lamp is used as a light source, as described above, the electrodes cannot be equally affected by heat dissipation, for example, with one electrode near to a light reflector. In a cold state, therefore, the liquid mercury adheres more to one electrode that is strongly affected by heat dissipation to decrease in temperature.

If the discharge lamp starts in this state, since electron cannot be easily emitted from the electrode on which the mercury is adhered, current cannot easily flow with one polarity in AC drive. If the polarity is changed in this state, the discharge state may change upon reversal, resulting in a glow discharge state or going out temporarily.

In the prior art, moreover, since the high-voltage pulse for starting is generated at a fixed timing determined by a CR time constant, it has been difficult to deal with the problems of going out or a glow discharge state.

### SUMMARY OF THE INVENTION

It is an object of the present invention to provide a discharge lamp lighting apparatus which can impart improved starting properties to a discharge lamp.

It is another object of the present invention to provide a discharge lamp lighting apparatus which can minimize electrode wear upon starting of a discharge lamp so as to extend the lifetime of the discharge lamp.

It is still another object of the present invention to provide a discharge lamp lighting apparatus which can minimize the change of electric discharge state and the time of going out upon starting so as to quickly and uniformly increase the temperature inside a discharge lamp.

To achieve at least one of the above-mentioned objects, the present invention provides a discharge lamp lighting apparatus comprising a DC/AC converter, a high-voltage generator, and a microprocessor. The DC/AC converter is adapted to convert a supplied direct voltage to an alternating voltage and then output the alternating voltage. The high-voltage generator is adapted to superpose a pulse voltage on the alternating voltage supplied from the DC/AC converter and then output the alternating voltage. The microprocessor is adapted to provide a timing to control the high-voltage generator in such a manner that the pulse voltage is superposed on the alternating voltage in synchronism with the alternating voltage.

As described above, since the discharge lamp lighting apparatus of the present invention includes a DC/AC converter for converting a supplied direct voltage to an alternating voltage and then outputting the alternating voltage and a high-voltage generator for superposing a pulse voltage on the alternating voltage supplied from the DC/AC converter and then outputting the pulse-superposed alternating voltage, a discharge lamp can be started by supplying the pulse-superposed alternating voltage to the discharge lamp. After lighting the discharge lamp, the discharge lamp can be kept lit by supplying the alternating voltage, which is output from the DC/AC converter, to the discharge lamp.

In addition, since the discharge lamp is started and kept lit by the pulse-superposed alternating voltage, the direction of emission and inflow of electron changes in accordance with frequency of the alternating voltage. This prevents that only one electrode will be worn by overheating, thereby minimizing the electrode wear upon starting of the discharge lamp and thus extending the lifetime of the discharge lamp.

The microprocessor provides a timing to control the high-voltage generator in such a manner that the pulse voltage is superposed on the alternating voltage in synchronism with the alternating voltage output from the DC/AC converter. This timing may be arbitrarily set in accordance with a previously set starting program of the microprocessor. In a cold state right after the starting, therefore, even if metal atom such as liquid mercury adheres more to one electrode that is strongly affected by heat dissipation to decrease in temperature and hampers the emission of electron therefrom, and, as a result, the electric discharge goes out right after polarity reversal, the next pulse-superposed alternating voltage facilitates breakdown and electric discharge, thereby minimizing the period of no current flow. Going out of electric discharge and occurrence of glow discharge can be generally detected with the microprocessor by detecting a tube current with a current detection circuit contained in discharge lamp lighting apparatuses of this type and supplying its detection signal to the microprocessor.

The control timing, which is to be supplied from the microprocessor to the high-voltage generator for superposing the pulse voltage on the alternating voltage, may be provided with a delay time based on the polarity reversal of the alternating voltage. Preferably, the delay time is in the range equal to or less than 10% of a half-cycle of the alternating voltage. More preferably, it is in the range equal to or less than 5%. It is also possible that the delay time=0, i.e., the pulse voltage may be superposed upon the polarity reversal of the alternating voltage.

Preferably, the alternating voltage has a frequency in the range of 40 Hz to a few hundred Hz, i.e., it is preferred to adopt a low frequency starting method. With the low frequency starting method, there can be avoided the current-limiting action of an inductor in the high frequency starting method and the following phenomena of producing a triangular current waveform and heating only one electrode. In case of the low frequency starting method, the delay time should be 1000 μs or less, preferably 500 μs or less, more preferably 100 μs or less.

According to the present invention, as has been described above, there can be obtained at least one of the following effects.
(a) To provide a discharge lamp lighting apparatus which can impart improved starting properties to a discharge lamp.
(b) To provide a discharge lamp lighting apparatus which can minimize electrode wear upon starting of a discharge lamp so as to extend the lifetime of the discharge lamp.
(c) To provide a discharge lamp lighting apparatus which can minimize the change of electric discharge state and the time of going out upon starting so as to quickly and uniformly increase the temperature inside a discharge lamp.

The present invention will be more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing a configuration of a discharge lamp lighting apparatus according to one embodiment of the present invention;

FIG. 2 is a diagram showing voltage waveform and current waveform of the discharge lamp lighting apparatus of FIG. 1; and

FIG. 3 is a block diagram showing a more detailed circuit configuration of a high-voltage generator in the discharge lamp lighting apparatus of FIG. 1.

### DESCRIPTION OF THE PREFERRED EMBODIMENTS

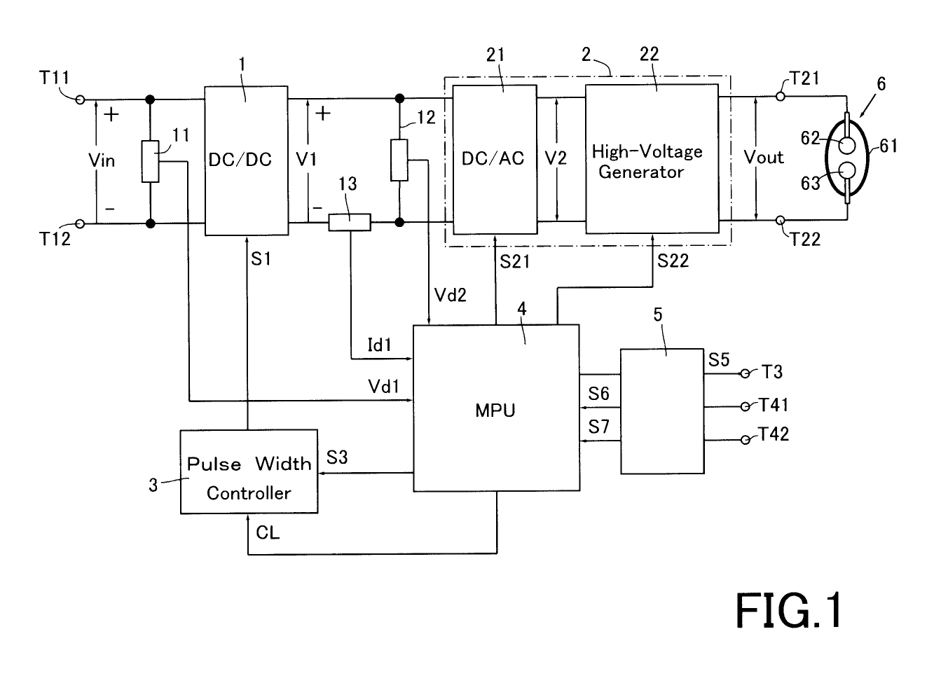

Referring to FIG. 1, the discharge lamp lighting apparatus is used to drive a discharge lamp 6 such as an HID lamp (high intensity discharge lamp). The HID lamp is of the type which utilizes arc discharge within a high-pressure metal vapor as a light source and is a general name for a high-pressure mercury lamp, a metal halide lamp, and a high-pressure sodium lamp. The discharge lamp 6 has a pair of spaced-apart electrodes 62, 63 within a tube 61 composed of a silica glass or the like, thereby utilizing arc discharge between the electrodes 62, 63 as a light source. Due to the absence of a filament, it has a longer life and is more efficient than a filament lamp. Because of its features such as high intensity, high efficiency, and a color temperature similar to sunlight, the metal halide lamp is in the mainstream of location lighting in the field of production lighting such as TV and movie production. Recently, it is also used as a headlight for automobiles and rail cars instead of a sealed-beam lamp and a halogen lamp.

In order to drive the above discharge lamp 6, the illustrated discharge lamp lighting apparatus includes a DC/DC converter 1, a discharge lamp driver 2, a pulse width controller 3, and a microprocessor 4.

The DC/DC converter 1 converts an input direct voltage Vin, which is supplied to input terminals T11, T12, to a direct voltage V1 of a different voltage value than the input direct voltage Vin by switching and then outputs the converted direct voltage V1. Since the voltage (tube voltage) between the electrodes 62, 63 of the discharge lamp 6 greatly varies between the starting operation and the stationary operation, the DC/DC converter 1 is provided, for example, to stabilize power consumption of the discharge lamp 6 regardless of such a variation. To the DC/DC converter 1, a pulse width controlled switching control signal S1 is supplied from the pulse width controller 3, and the switching operation is performed with a controlled pulse width by the DC/DC converter 1. The switching operation is performed by the DC/DC converter 1 at a switching frequency as high as 50 kHz or more.

As the DC/DC converter 1, generally, there may be adopted a step-down chopper circuit with a smoothing circuit (not shown) provided at its output stage. The smoothing circuit may be of a capacitor input type including a capacitor and an inductor. The input direct voltage Vin to be supplied to the DC/DC converter 1 is obtained by rectifying and smoothing a commercial AC source or supplied from another DC source.

The discharge lamp driver 2 converts the direct voltage V1, which is supplied from the DC/DC converter 1, to a pulse-superposed alternating voltage Vout suitable for driving the discharge lamp 6 and includes a DC/AC inverter 21 and a high-voltage generator 22. The DC/AC inverter 21 converts the direct voltage V1 supplied from the DC/DC converter 1 to an alternating voltage V2 by switching at a lower frequency than the DC/DC converter 1. Preferably, the switching frequency of the DC/AC inverter 21, i.e., the frequency of the alternating voltage V2 is in the range of 40 Hz to a few hundred Hz. In other words, it is preferred to adopt a low frequency starting method. The operation of the DC/AC inverter 21 is controlled by a control signal S21 supplied from the microprocessor 4.

Upon starting, the high-voltage generator 22 is provided with a timing to superpose a pulse voltage Vp on the alternating voltage V2 supplied from the DC/AC inverter 21 and then output the alternating voltage.

The microprocessor 4 controls the apparatus as a whole and provides a timing to control the high-voltage generator 22 in such a manner that the pulse voltage Vp is superposed on the alternating voltage V2 in synchronism with the alternating voltage V2. The timing of superposing the pulse voltage Vp on the alternating voltage V2 is determined by a program incorporated in the microprocessor 4. Thus, the superposing timing of the pulse voltage Vp may be arbitrarily set using a program.

As general components, the illustrated discharge lamp lighting apparatus further includes a voltage detection circuit 12, a current detection circuit 13, an input voltage detection circuit 11, and a communication unit 5. The voltage detection circuit 12 detects the direct voltage V1, which is to be supplied to the discharge lamp driver 2, and supplies an obtained voltage detection signal Vd2 to the microprocessor 4. The microprocessor 4 changes frequency of a reference pulse CL, which is to be supplied to the pulse width controller 3, depending on a voltage value indicated by the voltage detection signal Vd2. The frequency control of the reference pulse CL is performed in accordance with a previously set program.

The current detection circuit 13 detects a current to be supplied to the discharge lamp driver 2 and supplies an obtained current detection signal Id1 to the microprocessor 4. The microprocessor 4 controls the DC/DC converter 1 in such a manner as to stabilize power consumption of the discharge lamp 6 depending on the current detection signal Id1 and the voltage detection signal Vd2. This enables the constant power control. The constant power control is also performed in accordance with a previously set program of the microprocessor 4. Going out of electric discharge and occurrence of glow discharge can be detected by the microprocessor 4 with the current detection signal Id1 supplied from the current detection circuit 13 to the microprocessor 4.

The input voltage detection circuit 11 monitors the input direct voltage Vin and supplies an obtained voltage detection signal Vd1 to the microprocessor 4. In the case where the input direct voltage Vin is extremely decreased, for example, the microprocessor 4 supplies a protective operation signal such as a stop signal to the pulse width controller 3 depending on the voltage detection signal Vd1 supplied from the input voltage detection circuit 11.

The communication unit 5 has an insulating transmission circuit including, for example, a photocoupler and is connected to a communication port of the microprocessor 4. The communication unit 5 functions to send out a transmission signal S5, which includes control information of the microprocessor 4, from an output terminal T3 and also functions to supply to the microprocessor 4 a lighting instruction signal S6 and a received signal S7, which are supplied from the outside to an input terminal T41 and an input terminal T42, respectively.

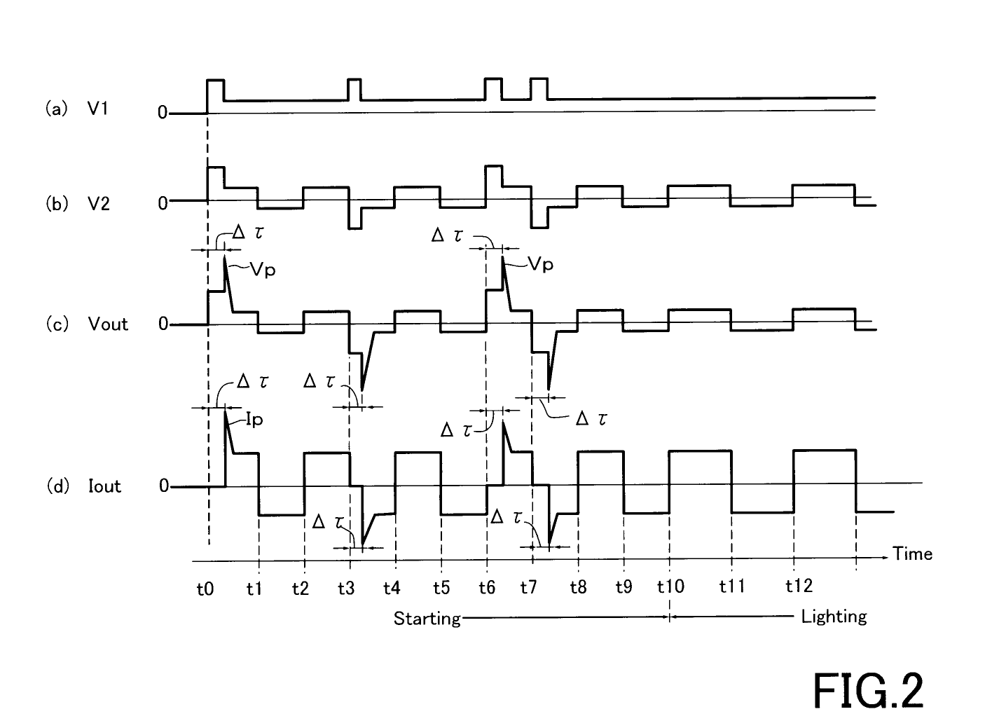

Next will be described the operation of the discharge lamp lighting apparatus of FIG. 1, particularly the starting operation, with reference to FIG. 2.

First of all, as shown in FIG. 2(a), the DC/DC converter 1 starts to operate at the time of t0, and the input direct voltage Vin is switched by the DC/DC converter 1 and converted to the direct voltage V1 of a different voltage value than the input direct voltage Vin.

To the DC/DC converter 1, the switching control signal S1 is supplied from the pulse width controller 3, and the switching operation is performed by the DC/DC converter 1 in accordance with the switching control signal S1. In the illustrated embodiment, the switching control signal S1 supplied from the pulse width controller 3 to the DC/DC converter 1 is generated from a pulse width control signal S3 and the reference pulse CL supplied from the microprocessor 4. However, it is also possible to generate the reference pulse CL within the pulse width controller 3.

The direct voltage V1 converted by the DC/DC converter 1 is supplied to the discharge lamp driver 2. The discharge lamp driver 2 converts the direct voltage V1, which is supplied from the DC/DC converter 1, to a voltage suitable for driving the discharge lamp 6. The DC/AC inverter 21 of the discharge lamp driver 2 converts the direct voltage V1, which is supplied from the DC/DC converter 1 at the time of t0, to the alternating voltage V2 and outputs the alternating voltage V2 (see FIG. 2(b)). When the discharge lamp 6 remains off, generally, the alternating voltage V2 takes the form of a rectangular wave, for example, of about 300V (in peak value).

The high-voltage generator 22 superposes the pulse voltage Vp on the alternating voltage V2 supplied from the DC/AC inverter 21 in synchronism with the alternating voltage V2 and then outputs the pulse-superposed alternating voltage Vout (see FIG. 2(c)). The pulse-superposed alternating voltage Vout is supplied to the pair of electrodes 62, 63 of the discharge lamp 6. Thus, breakdown occurs between the electrodes 62, 63 of the discharge lamp 6, whereby a tube current lout starts to flow (see FIG. 2(d)). The pulse voltage Vp has sharp rise and fall characteristics with a short duration. The peak value of the pulse-superposed alternating voltage Vout is set to about 10 kV.

The timing of superposing the pulse voltage Vp on the alternating voltage V2 may be arbitrarily set using a program incorporated in the microprocessor 4.

After the tube current lout flows as described above, the tube current Iout then goes out during the period between the time of t3 and Δ τ where the polarity of the alternating voltage V2 is reversed to negative. Going out of the tube current Iout can be detected by the current detection circuit 13 and the detection signal Id1 is supplied to the microprocessor 4. When the current detection signal Id1 indicating that the tube current Iout goes out is supplied, the microprocessor 4 again superposes the pulse voltage Vp with a delay time corresponding to Δ τ.

With this second superposition of the pulse voltage Vp, the tube current Iout again starts to flow and reaches the time of t4 after a half-cycle. At the time of t4, if going out of the tube current Iout is not detected right after the polarity reversal of the alternating voltage V2 to positive, it is not necessary to generate the pulse voltage Vp.

Let it be assumed that the tube current Iout, which continued to flow from the time of t3 to the time of t4 after a half-cycle, again goes out at the moment of the polarity reversal of the alternating voltage V2 to positive at the time of t6 after a half-cycle from the time of t5 when the polarity of the alternating voltage V2 is reversed to negative. Going out of the tube current Iout at this time is also detected by the current detection circuit 13 and the detection signal Id1 is supplied to the microprocessor 4. When the current detection signal Id1 indicating that the tube current Iout goes out is supplied, the microprocessor 4 again superposes the pulse voltage Vp with a delay time corresponding to Δ τ.

By repeating such an operation, the temperature inside the tube can be increased to vaporize metal atom such as mercury adhered to the electrode 62 or 63 and eliminate the phenomenon that the tube current Iout goes out, whereby the discharge lamp 6 moves from the starting state to the lighting state. In FIG. 2, the lighting state starts from the time of t10.

In the illustrate embodiment, as understood from the description of the operation, the discharge lamp 6 is started by the polarity-reversing pulse-superposed alternating voltage Vout and kept lit by the alternating voltage, so that the direction of emission and inflow of electron changes in accordance with the frequency of the alternating voltage V2. This prevents that only one of the electrodes 62, 63 of the discharge lamp 6 will be worn by overheating, thereby minimizing the electrode wear upon starting of the discharge lamp 6 and thus extending the lifetime of the discharge lamp 6.

In addition, the timing of superposing the pulse voltage Vp on the alternating voltage V2 supplied from the DC/AC inverter 21 and outputting it depends on a program of the microprocessor 4. In accordance with the incorporated program, the microprocessor 4 controls the high-voltage generating circuit 22 in such a manner that upon starting, the pulse voltage Vp is superposed on the alternating voltage V2 in synchronism with the alternating voltage V2 output from the DC/AC converter 21. Thus, upon starting, the pulse-superposed alternating voltage Vout is applied to the discharge lamp 6 from the high-voltage generator 22.

In a cold state right after the starting, therefore, even if metal atom such as liquid mercury adheres more to one electrode 62 or 63 that is strongly affected by heat dissipation to decrease in temperature and hampers the emission of electron therefrom, and, as a result, the electric discharge goes out right after polarity reversal, immediate superposition of the pulse voltage Vp facilitates breakdown and electric discharge, thereby minimizing the period of no current flow.

The control timing, which is to be supplied from the microprocessor 4 to the high-voltage generator 22 for superposing the pulse voltage Vp on the alternating voltage V2, may be provided with a delay time Δ τ based on the polarity reversal of the alternating voltage V2. Preferably, the delay time Δ τ is in the range equal to or less than 10% of a half-cycle of the alternating voltage V2. More preferably, it is in the range equal to or less than 5%. It is also possible that the delay time Δ τ=0, i.e., the pulse voltage Vp may be superposed upon the polarity reversal of the alternating voltage V2.

Preferably, the alternating voltage V2 has a frequency in the range of 40 Hz to a few hundred Hz, i.e., it is preferred to adopt a low frequency starting method. With the low frequency starting method, there can be avoided the current-limiting action of an inductor in the high frequency starting method and the following phenomena of producing a triangular current waveform and heating only one electrode. In case of the low frequency starting method, the delay time Δ τ should be 1000 μs or less, preferably 500 μs or less, more preferably 100 μs or less.

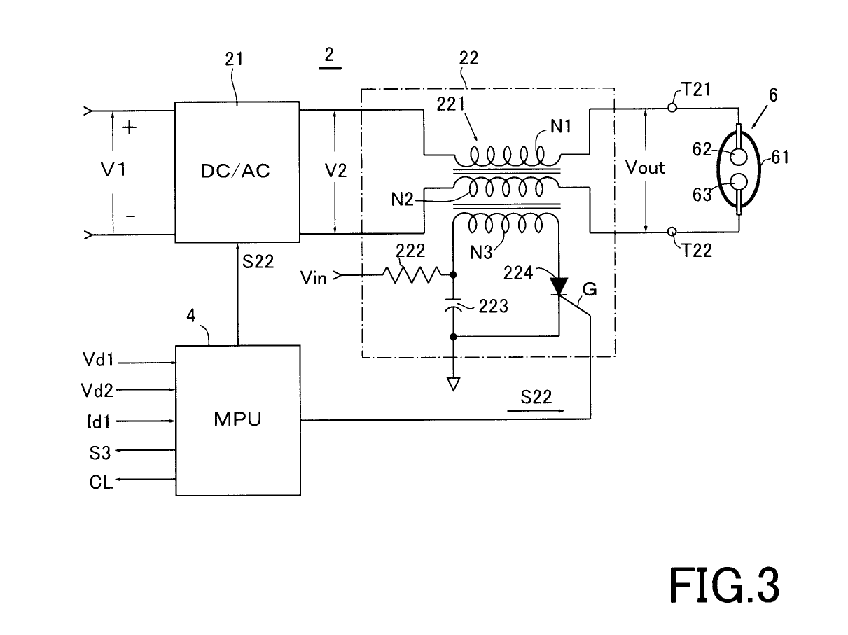

FIG. 3 shows a more detailed circuit configuration of the high-voltage generator 22. Referring to FIG. 3, the high-voltage generator 22 includes a high-voltage pulse transformer 221, a capacitor 223 for generating a high voltage, a charging resistor 222, and a triode switch element 224 such as a thyristor or an IGBT.

The high-voltage pulse transformer 221 includes inductively-coupled first to third windings N1 to N3. The first winding N1 has one end connected to one output end of the DC/AC converter 21 and the other end connected to a terminal T21. The second winding N2 has one end connected to the other output end of the DC/AC converter 21 and the other end connected to a terminal T22.

To the third winding N3, a main electrode circuit of the triode switch element 224 and the capacitor 223 are connected in series with one end of the charging resistor 222 being connected to a connection point between the third winding N3 and the capacitor 223. To the other end of the resistor 222, there is supplied a charging power Vin. To a gate G of the triode switch element 224, on the other hand, there is supplied a gate trigger signal S22 from the microprocessor 4.

When the gate trigger signal S22 is supplied to the gate G of the triode switch element 224 upon starting from the microprocessor 4 in accordance with its program, the triode switch element 224 conducts, thereby discharging an electric charge, which is accumulated in the capacitor 223 by the resistor 222, through the third winding N3 and generating a pulse voltage in the third winding N3. Then, because of the inductive coupling between the third winding N3 and the first or second winding N1 or N2, the pulse voltage Vp corresponding to the winding number is generated in the first or second winding N1 or N2 and superposed on the alternating voltage V2. This generates the pulse-superposed alternating voltage Vout, i.e., the alternating voltage V2 on which the pulse voltage Vp is superposed.

While the present invention has been particularly shown and described with reference to embodiments thereof, it will be understood by those skilled in the art that various changes in form and detail may be made therein without departing from the spirit, scope and teaching of the invention.

What is claimed is:

1. A discharge lamp lighting apparatus comprising:
a DC/AC converter for converting a supplied direct voltage to an alternating voltage and then outputting the alternating voltage;
a high-voltage generator for superposing a pulse voltage on the alternating voltage supplied from said DC/AC converter and then outputting the alternating voltage; and
a microprocessor for providing a timing to control said high-voltage generator in such a manner that the pulse voltage is superposed on the alternating voltage in synchronism with the alternating voltage.

2. The discharge lamp lighting apparatus of claim 1, wherein the timing is provided with a delay time based on polarity reversal of the alternating voltage, and the delay time is in a range equal to or less than 10% of a half-cycle of the alternating voltage.

3. The discharge lamp lighting apparatus of claim 2, wherein the alternating voltage has a frequency in a range of 40 Hz to a few hundred Hz.
